(19) United States
(12) Patent Application Publication
(10) Pub. No.: US 2002/0158896 A1
(43) Pub. Date: Oct. 31, 2002

(54) Information gathering method and system

(75) Inventors: Takuro Ikeda, Kawasaki (JP); Takahiro Kii, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/961,181

(22) Filed: Sep. 24, 2001

(30) Foreign Application Priority Data
Apr. 26, 2001 (JP) 2001-129493

(51) Int. Cl. G06F 13/00

(52) U.S. Cl. 345/733

(57) ABSTRACT

An object of the present invention is to conveniently gather and put to use market needs. Utilizing a dialogue scenario a dealer selling merchandise, in place of the manufacturer creating the merchandise, surveys customers. The dialogue scenario takes place through an information-gathering device 3 installed in the dealer's shop or the like. The information-gathering device 3 transmits the dialogue content to the manufacturer's terminal 2 via a network 4. The dialogue scenario is, ordinarily, prepared by a research company so that information that is the manufacturer's objective maybe gathered. The manufacturer efficiently gathers results of questionnaires on its own merchandise, which can be exploited in marketing. The dealer earns a profit by providing on commission the information, gathered in place of the manufacturer, to the manufacturer. A dealer's offering compensation to customers responding to the questionnaire for the customers becomes an incentive to go through the dialogue, and for the dealer the compensation enables growth in preferred customers.

### TITLE OF THE INVENTION

1. Technical Field

The present invention relates to a method and system for automatic transmission of the content of dialogues exchanged between computers and customers based on a dialogue scenario.

2. Description of Related Art

Marketing strategies that research customer reactions to merchandise and feed the reactions back into the development of the next generation of merchandise are vital and indispensable in business. Moreover, by gathering and analyzing such personal customer information as merchandise purchasing histories and profile information, customers' individual needs are predicted precisely. Rapidly providing information on merchandise customers are likely to want next is crucial for improving customer satisfaction levels. At present, questionnaire surveys using postcards, and monitor surveys that in seeking opinions regarding merchandise demand the customer's cooperation in part, are in general the means through which businesses obtain customers' thoughts and impressions regarding merchandise.

For businesses, conducting the conventional questionnaire or monitor surveys requires time and expense, which moreover ends up obliging customers also to go to much trouble. Furthermore, it is difficult to tell whether customer information thus obtained is either quantitatively or qualitatively sufficient. For example, questionnaire surveys are generally conducted by having a questionnaire postcard that comes with the purchased merchandise filled out and sent in. Nevertheless, various inquiries and questions up to the point where purchase is made cannot be had by this method. Also, intermingled among the collected questionnaire postcards are those with omissions and meaningless answers that are of no benefit as far as businesses are concerned; and it takes cost and labor to sort through them.

Further, questionnaire surveys through postcards are one-sided, and for gathering effective information are limited. For example, on a questionnaire where the substance of a question is unclear a customer may have uncertainty. Because the customer cannot confirm what the question means in such cases, it is hard to make an effective answer. In addition, if the customer would like to know how merchandise that is the subject of a questionnaire works in detail, the customer cannot answer the questionnaire and at the same time ask his or her questions. Businesses therefore cannot learn in what merchandise customers possess an interest.

From the viewpoint of gathering effective questionnaire results, oral-based questionnaire surveys are a more preferable method than postcard-based questionnaire surveys. In order to gather effective survey results, however, personnel having accurate knowledge of the survey content and of the merchandise must carry out the survey. Getting hold of such personnel is expensive and time-consuming. Moreover, while businesses conceivably could call for oral-based questionnaire surveys at franchises, owing to the expense burden issue, it likely would be hard to get cooperation from franchises for the questionnaire surveys.

### SUMMARY OF THE INVENTION

An object of the present invention is to provide a technique and the technology that make it possible conveniently to gather and exploit market needs.

In order to solve the aforementioned problems, a first aspect of the present invention provides an information-gathering method employed in an information-gathering system for holding dialogues with customers based on dialogue scenarios. The information-gathering method comprises the following steps:

a scenario-storing step of assigning correspondences between, and storing, dialogue scenarios, and send-destination addresses for content of dialogues performed following the dialogue scenarios;

an extraction step of extracting from the stored dialogue scenarios a dialogue scenario to be performed;

a dialogue step of holding a dialogue with a customer following the dialogue scenario and acquiring content of the dialogue;

a dialogue transmission step of transmitting the dialogue content to the send-destination address corresponding to the dialogue scenario;

a dialogue storing step of storing the transmitted dialogue content; and

an output step of outputting the dialogue content stored in the dialogue storing step.

The dialogue scenario is prepared, for example, with the aim of drawing out needs regarding merchandise. With this method, needs that the dialogue scenario draws out regarding merchandise-in other words the dialogue content-are transmitted to the businesses for the merchandise providers. The dialogue scenarios are programs written in a language such as VoiceXML, and are performed on computers installed in retail outlets.

On the part of businesses, extensively gathering and putting to use in marketing the needs of valued consumers serves to increase profits. Further, dealers at retail shops can make a profit by gathering information useful for business and for a commission turning over the information to businesses. Businesses or dealers may offer compensation to consumers who provide useful information. Dealers offering compensation to consumers raises the possibility that those consumers will become preferred customers for the dealer, so that the dealers can work toward customer growth.

It will be understood that dialogue scenarios may be prepared on a merchandise item-by-item basis to explain differences in merchandise offered from a plurality of companies. Conceivable for example is a dialogue scenario for drawing out consumer needs in explaining the pros and cons of PCs (personal computers) that A Corp., B Corp. and C Corp. offer. Further, dialogue scenarios may be prepared for every merchandise item at each of the companies. Conceivable for example is a dialogue scenario for drawing out consumer needs in explaining details of A Corp.'s PCs.

A dialogue based on a dialogue scenario is held as follows. The information-gathering device outputs questions by voice or text, and acquires a customer's answers to those questions. To acquire the information Customer Name, for example, the information-gathering device voice-outputs “Please tell me your name” via a speaker(s). When the customer in response to this voice-inputs “My name is Taro Fujitsu” through a microphone, the substance of the question and answer is acquired as dialogue content. Herein, needed information may be extracted as answer content from the customer's reply. For example, “Taro Fujitsu” can be extracted from the customer's utterance, “My name is Taro Fujitsu.”

The second aspect of the present invention provides a device for holding dialogues with customers based on dialogue scenarios. The information-gathering device includes the following means:

scenario storage means for assigning correspondences between and storing dialogue scenarios, and send-destination addresses for content of dialogues performed following the dialogue scenarios;

extraction means for extracting from the stored dialogue scenarios a dialogue scenario to be performed;

dialogue means for holding a dialogue with a customer following the dialogue scenario and for acquiring content of the dialogue; and

information transmission means for transmitting the dialogue content to the send-destination address corresponding to the dialogue scenario.

This information-gathering device executes the foregoing method in the first aspect of the invention.

The third aspect of the present invention provides the information-gathering device set forth in the second aspect. The information-gathering device further includes the following means:

customer information storage means for assigning correspondences between and storing customer-identifying data for identifying a customer, and customer information;

customer-specifying means for accepting input of the customer-identifying data; and

processing means for extracting from the customer information storage means, and annexing to the dialogue content, customer information corresponding to the input customer-identifying data.

Numbers for credit cards the customers hold, membership numbers, customer e-mail addresses, and telephone numbers, for example, may conceivably be utilized as the customer-identifying data.

Customer information is, for example, customer name, sex, age, and past brands purchased. Annexing customer information to dialogue content is writing customer information and dialogue content into a single file.

The fourth aspect of the present invention provides the information-gathering device set forth in the second aspect which further includes dialogue storage means for storing the dialogue content.

The fifth aspect of the present invention provides the information-gathering device set forth in the second aspect which further includes merchandise-specifying means for accepting input of merchandise identification data for identifying merchandise, wherein:

the scenario storage means correspondingly assigns to the dialogue scenarios, and further stores, merchandise identification data, and moreover stores as the send-destination addresses communications addresses for providers of the merchandise identified by the merchandise identification data;

the extraction means extracts dialogue scenarios corresponding to input merchandise identification data; and

the information transmission means transmits the dialogue content to the communications addresses corresponding to the merchandise identification data.

This aspect of the invention is useful in instances in which merchandise providers want with regard to their companies' merchandise to gather users' feelings. Through this information-gathering device, dialogue scenarios and send-destination addresses are assigned one-to-one correspondences with merchandise IDs. When a customer desiring to learn details about merchandise specified by a certain merchandise ID inputs the merchandise ID, a dialogue scenario regarding the merchandise is performed. The content of that dialogue is transmitted to the merchandise provider.

The sixth aspect of the present invention provides the information-gathering device set forth in the second aspect which further includes a merchandise name-specifying means for accepting merchandise classification input, wherein:

the scenario storage means further stores merchandise classifications, and moreover stores as the send-destination addresses communications addresses for providers of merchandise identified by the merchandise classifications;

the extraction means extracts a dialogue scenario corresponding to an input merchandise classification; and

the information transmission means transmits the dialogue content to the communications addresses corresponding to the input merchandise classification.

This aspect of the invention is useful wherein a merchandise provider wants to gather what sort of pros and cons there are in the company's own merchandise compared with other companies' merchandise. Through this information-gathering device, dialogue scenarios corresponding to merchandise names for, e.g., Personal Computers are extracted, and dialogue content is transmitted to a plurality of businesses that provide personal computers.

The seventh aspect of the present invention provides the information-gathering device set forth in the second aspect. The information-gathering device further includes the following means:

criteria storage means for storing billing criteria for billing for transmitted dialogue content;

billing means for determining based on the billing criteria billing totals regarding the dialogue content; and

notification means for reporting the billing totals to the send-destination addresses for the dialogue content.

Billing criteria may be, to give examples, number of keywords contained in a dialogue, transmission counts for dialogue content, and dialogue content information volume. For example, the information-gathering device determines dialogue content value each time dialogue content is acquired. Again for example, dialogue content may be stored for one month, and a value for month's worth of dialogue content may be determined. Dealerships where the information-gathering device is installed can gain profits by turning over the dialogue content at a commission.

The eighth aspect of the present invention provides the information-gathering device set forth in the second aspect. The information-gathering device further includes the following means:

compensation criteria storage means for assigning correspondences between, and storing, evaluation criteria for determining compensation provided to the customer according to the acquired dialogue content, and the compensation;

compensation determining means for determining compensation for the dialogue based on the evaluation criteria; and

compensation notification means for reporting compensation to the customer with whom the dialogue has been held.

“Evaluation criteria” are similar to the billing criteria just noted. The compensation may be, to give examples, rebates, discounts, premiums and like offers.

The ninth aspect of the present invention provides a computer-readable storage medium on which is recorded an information-gathering program utilized in an information-gathering device for holding dialogues with customers based on dialogue scenarios. The program executes the following steps:

a scenario-storing step of assigning correspondences between, and storing, dialogue scenarios, and send-destination addresses for content of dialogues performed following the dialogue scenarios;

an extraction step of extracting from the stored dialogue scenarios a dialogue scenario to be performed;

a dialogue step of holding a dialogue with a customer following the dialogue scenario and acquiring content of the dialogue; and

an information transmission step of transmitting the dialogue content to the send-destination address corresponding to the dialogue scenario.

Herein the storage medium may be, to give examples, computer-read/writeable floppy disks, semiconductor memory, CD-ROMs, DVDs, magneto-optical disks (MOs) and other recording media.

The tenth aspect of the present invention provides an information-gathering program for enabling a computer to hold dialogues with customers based on dialogue scenarios. The information-gathering program enables the computer to function as the following means:

scenario storage means for assigning correspondences between and storing dialogue scenarios, and send-destination addresses for content of dialogues performed following the dialogue scenarios;

extraction means for extracting from the stored dialogue scenarios a dialogue scenario to be performed;

dialogue means for holding a dialogue with a customer following the dialogue scenario and for acquiring content of the dialogue; and

information transmission means for transmitting the dialogue content to the send-destination address corresponding to the dialogue scenario.

The eleventh aspect of the present invention provides a computer terminal which includes the following means:

information-gathering means connected via a network to the information-gathering device set forth in claim 2, for gathering dialogue content transmitted from the information-gathering device;

information storage means for storing the gathered dialogue content; and

output means for outputting the stored dialogue content.

This computer terminal is utilized by manufacturers who manufacture the merchandise.

The twelfth aspect of the present invention provides an information-gathering method employed in an information-gathering system for holding dialogues with customers based on dialogue scenarios. The information-gathering method comprises the following steps:

a scenario-storing step of storing dialogue scenarios;

an extraction step of extracting from the dialogue scenarios a dialogue scenario to be performed;

a dialogue step of holding a dialogue with a customer following the dialogue scenario and acquiring content of the dialogue;

a first dialogue-storing step of storing the acquired dialogue content;

a sending-preferences designation step of accepting designation of sending preferences, and send-destination addresses, for the stored dialogue content;

a sending-preferences storage step of assigning correspondences between and storing the send-destination addresses and the sending preferences;

a transmission step of extracting from the stored dialogue content and transmitting to the send-destination addresses dialogue substance matching the sending preferences;

a second dialogue-storing step of storing the transmitted dialogue substance; and

an output step of outputting the dialogue substance stored in the second dialogue-storing step.

“Sending preferences” are, e.g., predetermined keywords contained within the acquired dialogue content, or a customer's age being within a certain range of numerical values.

By designating sending preferences through this method, merchandise providers are able to acquire from merchandise dealers dialogue content that matches the preferences. Suppose for example that A Corp. wants to learn public opinion regarding a DVD-R that is rival merchandise from competing B Corp. In this case, A Corp. may designate “B Corp.” and “DVD-R” as sending preferences. Changing the sending preferences as needed enables merchandise providers to draw out market needs broadly.

The thirteenth aspect of the present invention provides an information-gathering device for holding dialogues with customers based on dialogue scenarios concerning merchandise, connected via a network with computer terminals for providers of the merchandise. The information-gathering device comprises the following means:

scenario storage means for storing dialogue scenarios;

extraction means for extracting from the dialogue scenarios a dialogue scenario to be performed;

dialogue means for holding a dialogue with a customer following the dialogue scenario and for acquiring content of the dialogue;

dialogue storage means for storing the acquired dialogue content;

sending-preferences acceptance means for accepting from the computer terminals designation of sending preferences, and send-destination addresses, for the stored dialogue content;

sending-preferences storage means for assigning correspondences between and storing the send-destination addresses and the sending preferences; and

dialogue transmission means for extracting from the stored dialogue content and transmitting to the send-destination addresses dialogue substance matching the sending preferences.

By connecting on a network with computer terminals at the merchandise providers, this information-gathering device configures an information-gathering system for executing the method in the foregoing twelfth aspect of the invention.

The fourteenth aspect of the present invention provides a computer terminal connected via a network with dialogue devices for holding dialogues with customers based on dialogue scenarios concerning merchandise. The computer terminal includes the following means:

sending-preferences designation means for accepting designation of sending preferences, and send-destination addresses, for dialogue content acquired through the dialogue scenarios;

sending-preferences notification means for transmitting to the dialogue devices the designated sending preferences and send-destination addresses;

gathering means for gathering from the dialogue devices dialogue content matching the sending preferences;

dialogue storage means for storing dialogue content gathered by the gathering means; and

output means for outputting the dialogue content stored by the dialogue storage means.

By connecting on a network with information-gathering devices having to do with the foregoing thirteenth aspect of the invention, this computer terminal configures an information-gathering system for executing the method in the foregoing twelfth aspect of the invention.

From the following detailed description in conjunction with the accompanying drawings, the foregoing and other objects, featured, aspects and advantages of the present invention will become readily apparent to those skilled in the art.

### BRIEF DESCRIPTION OF THE DRAWINGS

FIG. 1 is an overall configurational view of an information-gathering system having to do with a first embodiment.

FIG. 2 is a conceptual explanatory diagram of information stored in a scenario DB in the FIG. 1 system.

FIG. 3 is a conceptual explanatory diagram of information stored in a customer DB in the FIG. 1 system.

FIG. 4 is a conceptual explanatory diagram of information stored in a log DB in the FIG. 1 system.

FIG. 5 is a conceptual explanatory diagram of information stored in a billing criteria DB in the FIG. 1 system.

FIG. 6 is a conceptual explanatory diagram of information stored in a billing DB in the FIG. 1 system.

FIG. 7 is a conceptual explanatory diagram of information stored in a compensation criteria DB in the FIG. 1 system.

FIG. 8 is a flow chart illustrating flow of a scenario acquisition routine in the FIG. 1 system.

FIG. 9 is a flow chart illustrating flow of a dialogue routine in the FIG. 1 system.

FIG. 10 is a conceptual explanatory diagram of a log file.

FIG. 11 is a flow chart illustrating flow of a transmission routine in the FIG. 1 system.

FIG. 12 is a flow chart illustrating flow of a billing routine in the FIG. 1 system.

FIG. 13 is a flow chart illustrating flow of a compensation routine in the FIG. 1 system.

FIG. 14 is an overall configurational view of an information-gathering system having to do with a second embodiment.

FIG. 15 is a conceptual explanatory diagram of information stored in a scenario DB in the FIG. 14 system.

FIG. 16 is an overall configurational view of an information-gathering system having to do with a third embodiment.

FIG. 17 is a conceptual explanatory diagram of send-destination DB in the FIG. 16 system.

FIG. 18 is a flow chart illustrating flow of a preferences designation routine in the FIG. 16 system.

FIG. 19 is a flow chart illustrating flow of a transmission routine in the FIG. 16 system.

FIG. 20 is an explanatory view illustrating one example of a sending-preferences designation screen in the FIG. 16 system.

### DETAILED DESCRIPTION OF THE PREFERRED EMBODIMENTS

Invention Overview

In an information-gathering method that relates to the present invention, a dealer selling merchandise, in place of the manufacturer creating the merchandise, utilizes a dialogue scenario to survey customers. A survey based on the dialogue scenario is performed in a conversational format through a computer (“information-gathering device” hereinafter) installed at the dealer's outlet or the like. The information-gathering device transmits the substance of the dialogue, i.e., the survey results, via a network to a computer at the manufacturer (“manufacturer terminal” hereinafter).

The dialogue scenario is a program that outputs questions concerning merchandise, the answers to which it acquires. The dialogue scenario is prepared so that information the manufacturer targets may be gathered. Conceivable dialogue scenarios might be for gathering impressions regarding manufacturers' new products, for example, or for popularity surveys on similar merchandise brought out by a number of manufacturers. These sorts of dialogue scenarios ordinarily would be prepared by research professionals who specialize in marketing surveys.

Employing a method according to the present invention, manufacturers, without going to trouble and expense, gather survey results on their own merchandise at low cost, which can then be exploited in marketing. Dealers meanwhile can anticipate earning a profit by providing to the manufacturer on commission the information concerning merchandise gathered in place of the manufacturer. Moreover, dealers may offer compensation to customers who have responded to the dialogue-scenario-based survey for them. This becomes an incentive for the customers to go through the dialogue, and for the dealer, the compensation enables growth in preferred customers.

First Embodiment

Configuration

(1) Overall Configuration

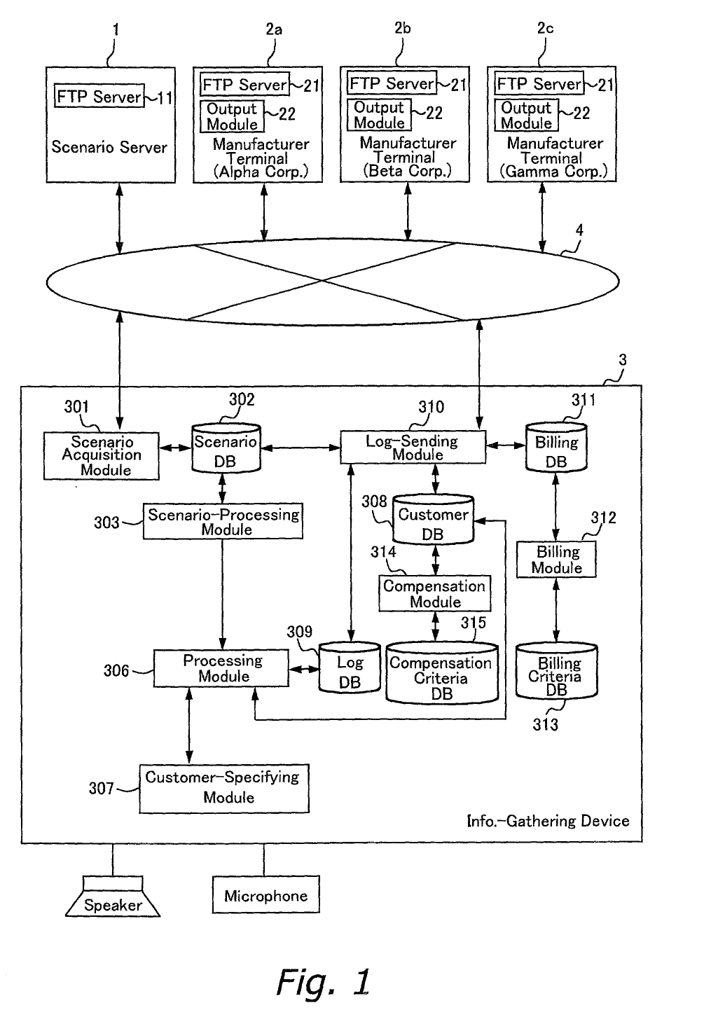

FIG. 1 is an overall configurational view of an information-gathering system in which an information-gathering method from the present invention is employed. The system includes a scenario server 1 connected via a network 4 such as the Internet, manufacturer terminals 2, and information-gathering device 3.

The scenario server 1 is a computer that an above-mentioned research professional administrates, and stores dialogue scenarios. In response to a request from the information-gathering device 3, the scenario server 1 transmits a dialogue scenario. Only one scenario server 1 is illustrated in the figure, but a plurality of scenario servers corresponding to a plurality of research professionals may be connected via the network 4. The scenario server 1 may be configured with an FTP server 11 for transmitting user-designated files to accessing users.

The manufacturer terminal 2 gathers and stores dialogue content transmitted from the information-gathering device 3. An FTP server 21 may be utilized as a means for gathering and storing dialogue content. The manufacturer terminal 2 also has an output module 22 that outputs the stored dialogue content to a display, printer, etc. Ordinarily a plurality of manufacturers is present, and a plurality of manufacturer terminals 2a, b, c is connected to the network 4.

The information-gathering device 3 acquires a dialogue scenario from the scenario server 1. The information-gathering device 3 also performs the dialogue scenario and transmits the substance of the dialogue to the manufacturer terminals 2. Only one information-gathering device 3 is illustrated in the figure, but ordinarily a plurality of information-gathering devices 3 is connected to the network 4.

(2) Information-Gathering Device

The information-gathering device 3 has a number of databases (DBs) and modules. Initially the DBs in the information-gathering device 3 will be explained, and then the module functions will be explained.

(2-1) Databases

The information-gathering device 3 includes scenario database 302, customer DB 308, log DB 309, billing criteria DB 313, billing DB 311, and compensation criteria DB 315.

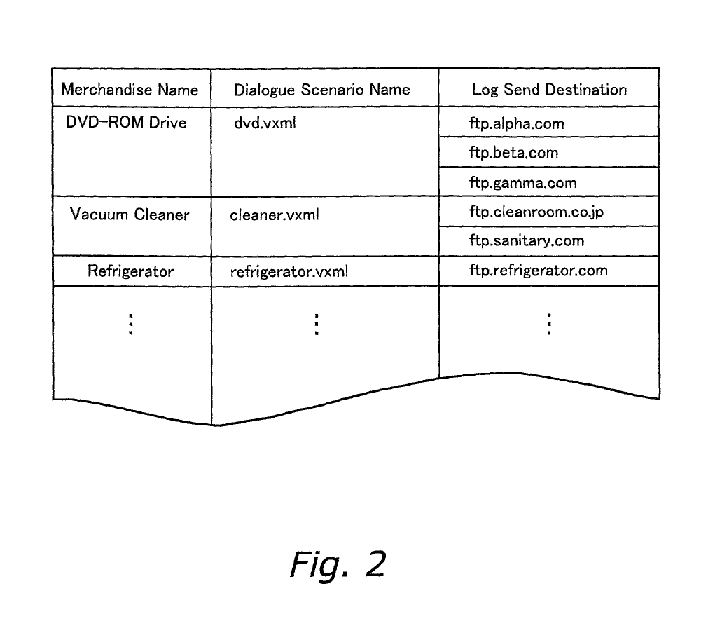

FIG. 2 is a conceptual explanatory diagram of information stored in the scenario DB 302. Dialogue scenarios and send destinations for dialogue content are stored in this DB. In this example, the scenario DB 302 assigns correspondences between and stores Merchandise Name, Dialogue Scenario Name, and Log Send Destination. The dialogue scenario name is an identifier that specifies a program stored in the scenario DB 302. In the present example, the file names of files written in VoiceXML are utilized as dialogue scenario names. An address indicating the storage location for the program may be utilized as the dialogue scenario name. The Log Send Destination is the send-destination address for the dialogue content obtained by performing the dialogue scenario. Now, the scenario DB 302 may store identifiers that indicate the file storage locations instead of the files themselves.

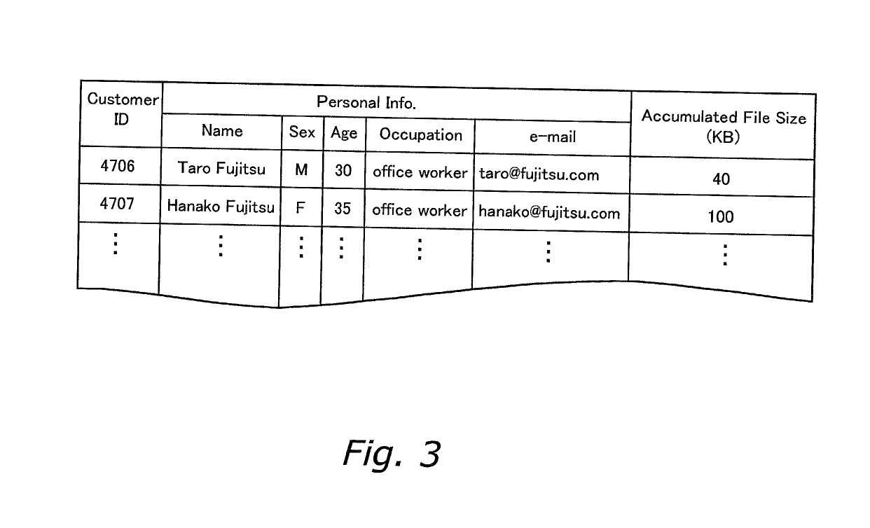

FIG. 3 is a conceptual explanatory diagram of information stored in the customer DB 308. Personal information concerning customers is stored in this DB.

In this example, Customer ID, customers' Personal Information, and Accumulated File Size are stored in the customer DB 308. The Customer ID is an identifying number for specifying a customer, and in this example, a customer's credit card number is used. E-mail addresses, telephone numbers, etc. conceivably might otherwise be used. A variety of dealer-gathered data pertaining to the customers is compiled in the Personal Information. In this example, Name, Sex, Age, Occupation, and E-mail Address are compiled as personal information. Other than this, the personal information may include, for example, purchasing history. The Accumulated File Size is the gross log-file size of the dialogue held by the customer.

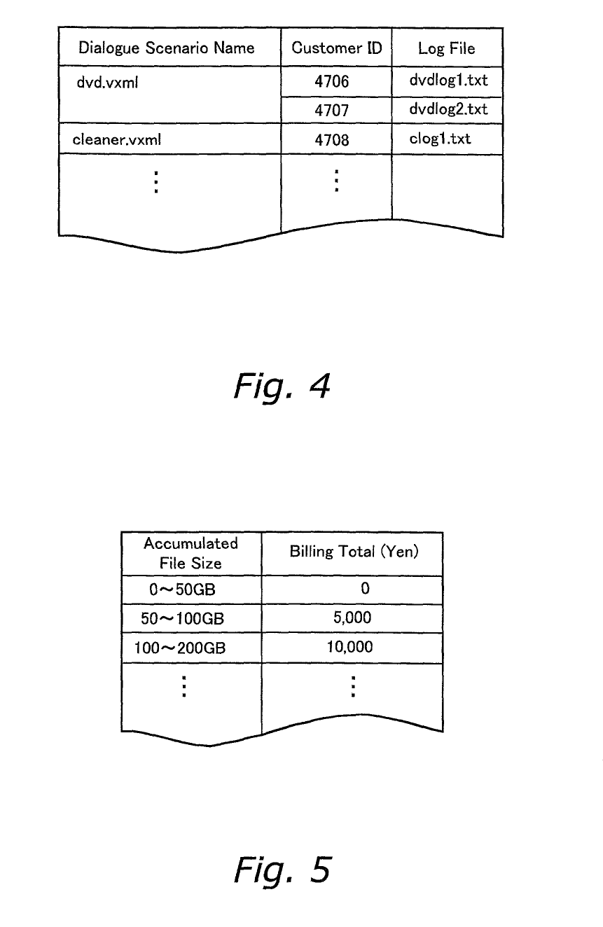

FIG. 4 is a conceptual explanatory diagram of information stored in the log DB 309. The content of the dialogues is stored in this DB. In this example, Dialogue Scenario Name, Customer ID, and Log File are stored in the log DB 309. Dialogue content and customer personal information are included in the Log File.

FIG. 5 is a conceptual explanatory diagram of information stored in the billing criteria DB 313. Computational criteria for total billings to the manufacturer are stored in this DB. In this example, Accumulated File Size and Billing Total are stored in the billing criteria DB 313. The billing criteria are set so that the billing total will correspond in expense to the size of the log file transmitted to the manufacturer.

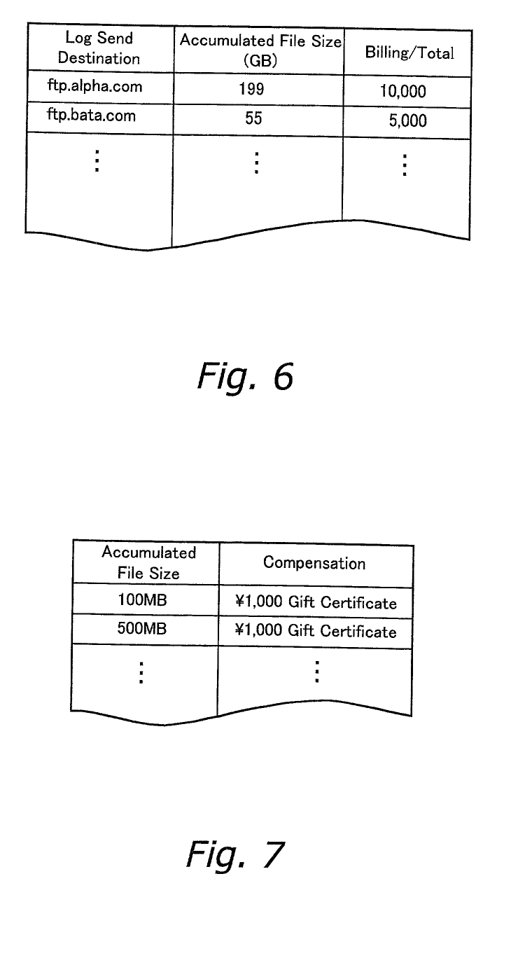

FIG. 6 is a conceptual explanatory diagram of information stored in the billing DB 311. Monthly totals billed to each manufacturer are stored in this DB. In this example, Log Send Destination, Accumulated File Size, and Billing Total are stored in the billing DB 311. The Log Send Destination, likewise as with the scenario DB 302, specifies a manufacturer. The Accumulated File Size is the one-month accumulated size of the dialogue log file transmitted to each manufacturer. The Billing Total is the monetary amount the manufacturer is charged as recompense for log file transmission.

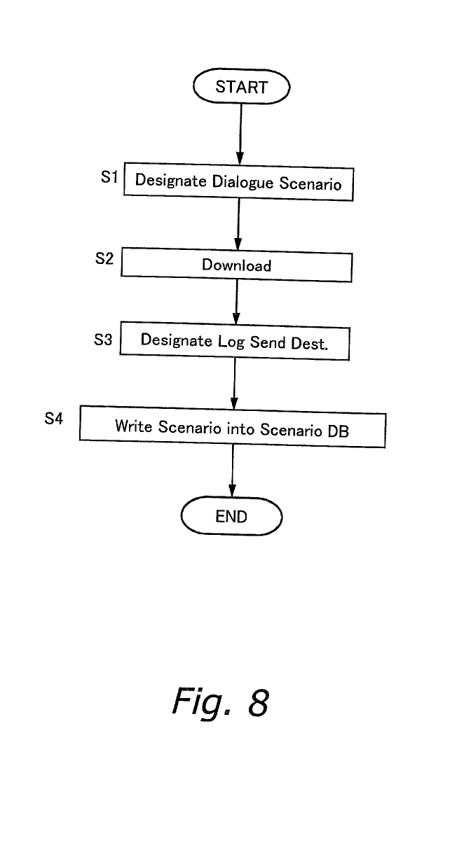

FIG. 7 is a conceptual explanatory diagram of information stored in the compensation criteria DB 315. Evaluation criteria for determining compensation to award to customers are stored in this DB. In this example, Accumulated File Size and Compensation are stored. The evaluation criteria are set so that the compensation increases according to the size of a customer's dialogue.

(2-2) Module Functions

The information-gathering device 3 includes a scenario acquisition module 301, a scenario-processing module 303, a processing module 306, a customer-specifying module 307, a log-sending module 310, a billing module 312, and a compensation module 314.

The scenario acquisition module 301 acquires a dialogue scenario from the scenario server 1, and assigns a log send destination to and writes the dialogue scenario in the scenario DB 302 (see FIG. 2).

The scenario-processing module 303 reads out from the scenario DB 302 and performs any of the dialogue scenarios. The scenario-processing module 303, for example, in accordance with the dialogue scenario performed outputs questions through a speaker (not shown in the figures), and acquires answers through a microphone (not shown in the figures). In the present example, since the dialogue scenarios are written in VoiceXML, questions are voice-output, but depending on how the dialogue scenario is designed, the questions may be output utilizing a display. For the same reason, input of answers from customers is accepted using a microphone in the present example, but answers may be accepted through a touch panel or keyboard, for instance.

The processing module 306 processes dialogue content based on the questions output in accordance with a dialogue scenario, and the answers input. Specifically, the processing module 306 converts voice data from the dialogue between the information-gathering device 3 and the customer into text data. The processing module 306 also generates a single data file that includes personal information from the customer DB 308 (see FIG. 3) and the dialogue text data. The processing module 306 writes the generated data file as a log file into the log DB 309 (see FIG. 4).

The customer-specifying module 307 accepts input of a customer's credit card number through a keyboard or magnetic card reader (not shown in the figures).

The log-sending module 310 at fixed periods, e.g., at daily intervals, consults the log DB 309 and transmits the log files stored in the log DB 309 to the manufacturer terminals 2. The send destination is determined by searching the scenario DB 302 on the dialogue scenario name corresponding to the log file as a key.

The billing module 312 updates the accumulated file size in the billing DB 311 for every transmission made to the manufacturer terminals 2. Based on the billing criteria DB 313, the billing module 312 at set periods, e.g., every month, also computes billing totals charged on the manufacturer.

On every occasion a dialogue is held with a customer, the compensation module 314 updates the customer's accumulated file size. Based on the compensation criteria DB 315, the compensation module 314 at set periods also determines compensation for customers.

Process Flow

Next, flow of processes that the information-gathering device 3 carries out will be specifically explained. To facilitate explanation below, the following assumptions will be presumed. Three manufacturers, Alpha Corp., Beta Corp., and Gamma Corp. manufacture a new product, a “DVD-ROM drive for personal computers”. Research company X Corp. prepares a dialogue scenario that compares the three companies' DVD-ROM drives, and stores it under the file name “dvd.vxml” in the scenario server 1. The manufacturers or else the research company notify the dealers of the network address for the scenario server 1, and of the file name “dvd.vxml.” The network addresses “ftp.alpha.com,” “ftp.beta.com,” and “ftp.gamma.com,” for the manufacturer terminals at Alpha Corp., Beta Corp., and Gamma Corp. are also reported to the dealers, as the log send destinations for the dialogue scenario “dvd.vxml.”

The information-gathering device 3 carries out a (1) scenario acquisition routine, a (2) dialogue routine, a (3) transmission routine, a (4) billing routine, and a (5) compensation routine.

In the following, a process in which by these routines the information-gathering device 3 acquires the dialogue scenario “dvd.vxml” from the scenario server 1, and prepares and transmits to the three manufacturer terminals a log file containing the dialogue content and personal information, will be explained.

(1) Scenario Acquisition Routine

FIG. 8 is a flow chart illustrating flow of the scenario acquisition routine. In the scenario acquisition routine, the scenario acquisition module 301 acquires the dialogue scenario from the scenario server 1. Pressing a “Download Scenario” button or the like, which is displayed by the acquisition module 301 on the display initiates the following routine.

Step S1: The dialogue scenario acquisition module 301 accepts a scenario server 1 designation and a file name “dvd.vxml” designation for a dialogue scenario.

Step S2: The dialogue scenario acquisition module 301 makes a download request for the designated dialogue scenario file “dvd.vxml” to, and acquires the file from, the scenario server 1 designated in step S1.

Step S3: The dialogue scenario acquisition module 301 requests, and accepts, input of the log send destination. Herein, “ftp.alpha.com,” “ftp.beta.com,” and “ftp.gamma.com” are input as the send destinations for the logs.

Step S4: The dialogue scenario acquisition module 301 correlates, and writes into the scenario DB 302, the log send destination accepted in step S4 and the downloaded dialogue scenario.

(2) Dialogue Routine

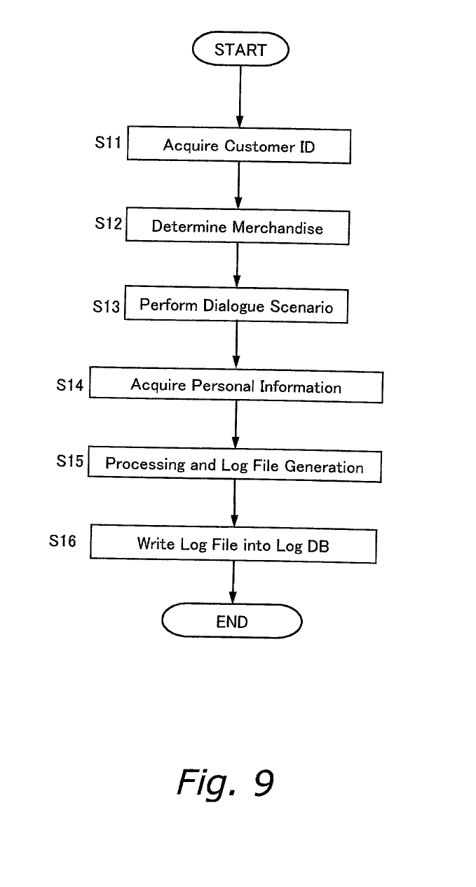

FIG. 9 is a flow chart illustrating flow of the dialogue routine. The scenario-processing module 303 performs dialogue scenarios, thereby acquiring dialogue content, and generates a log file containing personal information and the dialogue content. Inputting a customer ID through an input means (not shown in the figures) such as a card reader or keyboard launches the following routine.

Step S11: The customer-specifying module 307 acquires an input customer ID.

Step S12: The scenario-processing module 303 requests designation by the customer of a merchandise name, and accepts designation or else input of a merchandise name. Herein, an instance is supposed in which “DVD-ROM drive” has been designated as the merchandise name.

Step S13: The scenario-processing module 303 consults the scenario DB 302 and reads out the dialogue scenario corresponding to the designated merchandise name “DVD-ROM drive.” Subsequently, the scenario-processing module 303 performs the read-out dialogue scenario, and acquires dialogue content by holding a voice-based dialogue with the customer.

Step S14: The processing module 306 searches the customer DB 308 on, as a key, the customer ID acquired by the customer-specifying module 307, and from the customer DB 308 extracts, if available, personal information corresponding to the customer ID.

Step S15: The processing module 306 processes the dialogue content and generates a log file. Specifically, the processing module 306 converts the voice data from the dialogue content into text data, and generates a log file containing the extracted personal information and the text data. The form the log file may be, to give two examples, a text file or an XML file.

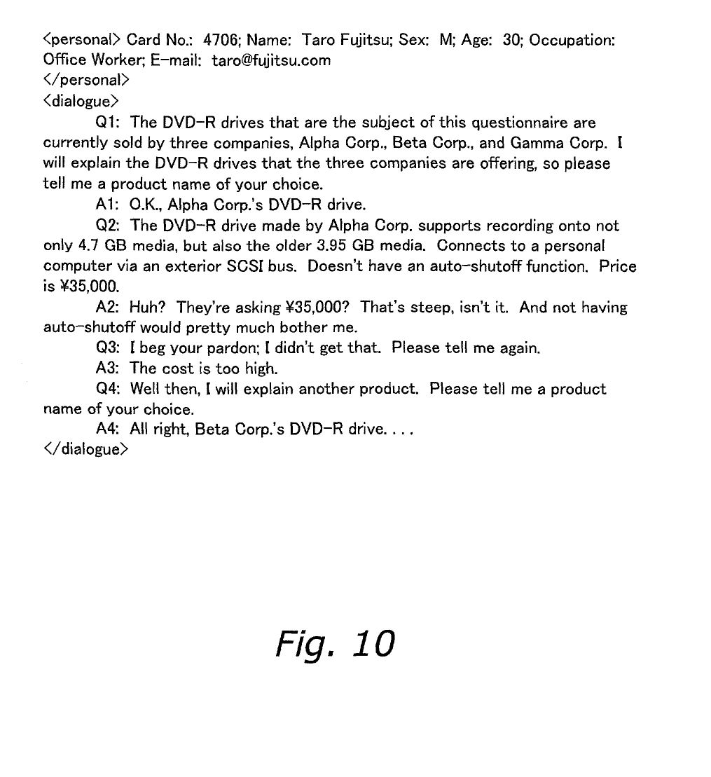

FIG. 10 is a conceptual explanatory diagram of a log file. Personal information, identified with the tag <personal>, and dialogue content, identified with the tag <dialogue>, are contained in the log file. In this example, questions made and answers given, following the dialogue scenario “dvd.vxml,” with regard to the DVD-ROM drive that is a new product for Alpha Corp., Beta Corp., and Gamma Corp., are recorded as the dialogue content.

Step S16: The processing module 306 assigns correspondences between, and writes into the log DB 309, the log file, the dialogue scenario name “dvd.vxml,” and the customer ID.

(3) Transmission Routine

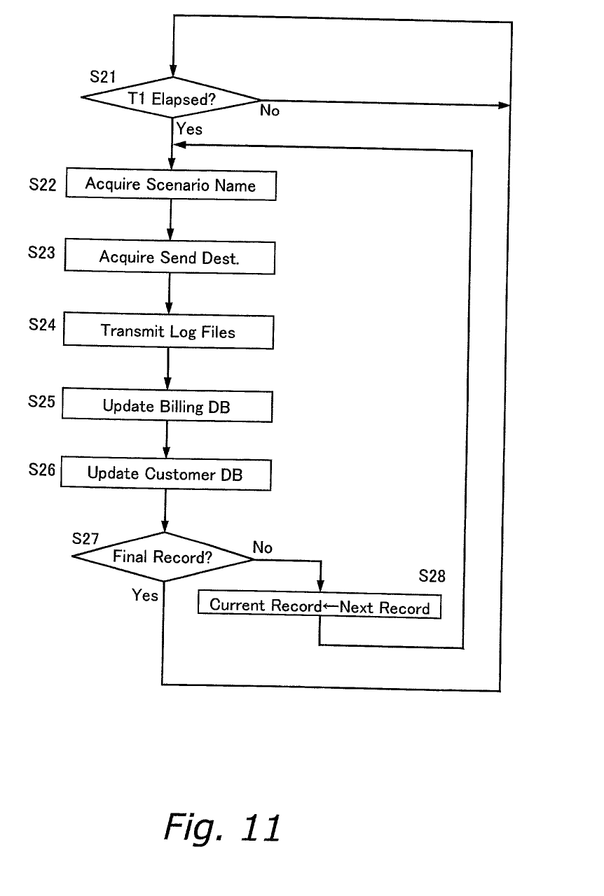

FIG. 11 is a flowchart illustrating flow of the transmission routine. In this routine the log-sending module 310 at fixed periods sends to the manufacturer terminals 2 the log files stored in the log DB 309.

Step S21: The log-sending module 310 judges whether or not a set time period T1 has elapsed since the last time log files were sent. If the time has elapsed, the following steps ensue for transmission of the log files. If the time has not elapsed, step S21 is repeated.

Step S22: The log-sending module 310 consults the current record in the log DB 309 and reads out the dialogue scenario name, customer ID and log file. The initial record is the default for the current record.

Step S23: The log-sending module 310 consults the scenario DB 302 and reads out the log send destination(s) that corresponds to the dialogue scenario name in the current record.

Step S24: The log-sending module 310 transmits the log file in the current record to the log send destination(s). If a number of log send destinations exist, the log file is sent respectively to each.

Step S25: The log-sending module 310 acquires the size of the log file in the current record, and updates the billing DB 311. That is, the log-sending module 310 updates the Accumulated File Size for the log send destination(s) by summing the log file size in the current record with the Accumulated File Size for the log send destination(s).

Step S26: Based on the log file size in the current record, the log-sending module 310 updates the customer DB 308. That is, the log-sending module 310 updates the Accumulated File Size for the customer ID by summing the log file size in the current record with the Accumulated File Size corresponding to the customer ID in the current record.

Step S27: The log-sending module 310 judges whether or not the current record is the last record. If it is the last record, all of the records within the log DB 309 are deleted, the routine returns to step S21, and stands by for time T1 to elapse. If it is not the last record, step S28 ensues.

Step S28: The log-sending module 310 sets as the current record the record succeeding the current record, and the step S22-S27 processes are repeated.

Thus, as in the foregoing, the log files stored in the log DB 309 are transmitted at fixed periods to the manufacturer terminals 2.

(4) Billing Routine

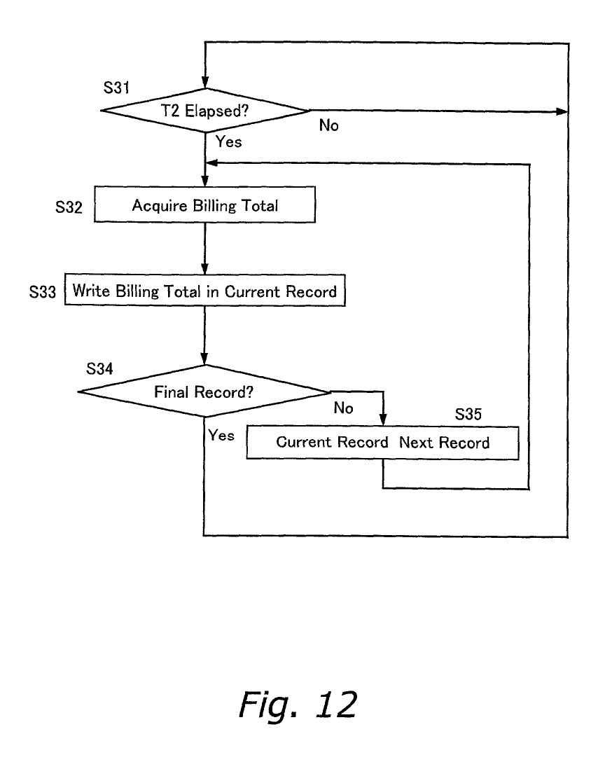

FIG. 12 is a flow chart illustrating flow of the billing routine that the billing module 312 carries out. In this routine, the billing module 312 performs billing-total determinations in fixed periods per log send destination.

Step S31: The billing module 312 judges whether or not a fixed time T2, e.g., one month has elapsed. If elapsed, step S32 ensues. If not elapsed, step S31 is repeated.

Step S32: The billing module 312 consults the current record in the billing DB 311 and reads out the Log Send Destination and the Accumulated File Size. The default for the current record is the initial record. The billing module 312 acquires from the billing criteria DB 313 the billing total that corresponds to the read-out accumulated file size.

Step S33: The billing module 312 writes the acquired billing total into the Billing Total in the current record. Further, the billing module 312 by e-mail, for instance, reports the written-in billing total to the read-out log send destination.

Steps S34, S35: The billing module 312 judges whether or not the current record is the last record. If it is the last record, the routine returns to step S31 and once again stands by for time T2 to elapse (S34). If it is not the last record, the next record is put as the current record (S35), and the above-noted steps S32-S34 processes are repeated.

Thus, as in the foregoing, totals for billing to the manufacturers are determined, e.g., every month.

(5) Compensation Routine

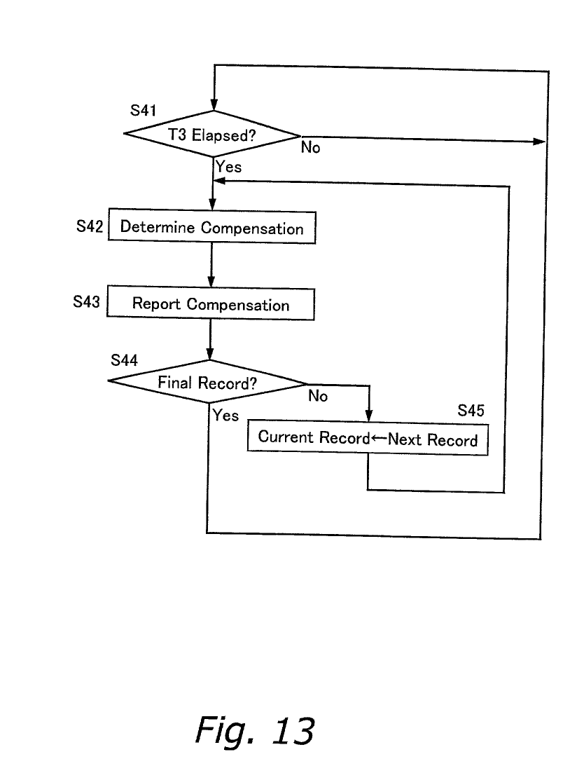

FIG. 13 is a flow chart for a compensation routine that the compensation module 314 carries out. The compensation module 314 in this routine makes compensation determinations for, and reports at fixed periods, e.g., once a month to, customers from whom dialogues have been had.

Step S41: The compensation module 314 judges whether or not a fixed time T3, e.g., one month has elapsed. If elapsed, step S42 ensues. If not elapsed, step S41 is repeated.

Step S42: The compensation module 314 consults the current record in the customer DB 308 and reads out the Accumulated File Size. The default for the current record is the initial record. The compensation module 314 acquires from the compensation criteria DB 315 the compensation that corresponds to the read-out accumulated file size.

Step S43: The compensation module 314, using the “e-mail” address in the current record, reports the compensation to the customer. For example, e-mail in which is written a hyperlink to a Web Page posting a discount coupon is sent to the customer. It will be understood that if a customer's accumulated file size does not meet the minimum criterion no notification is made.

Steps S44, 45: The compensation module 314 judges whether or not the current record is the last record. If it is the last record, the routine returns to step S41 and once again stands by for time T3 to elapse (S44). If it is not the last record, the next record is put as the current record (S45), and the above-noted steps S42-S44 are repeated.

Thus, as in the foregoing, compensation is determined for and reported to customers, e.g., every month.

Second Embodiment

In an information-gathering system having to do with a second embodiment, a customer's designating a merchandise ID determines the dialogue scenario and its send destination. This system is suitable for the manufacturers to conduct detailed questionnaires on their companies' merchandise to the customers. A dialogue scenario is prepared for each merchandise item. The log file for each dialogue scenario is sent only to the manufacturer terminal(s) for the merchandise, and are not sent to other, rival companies.

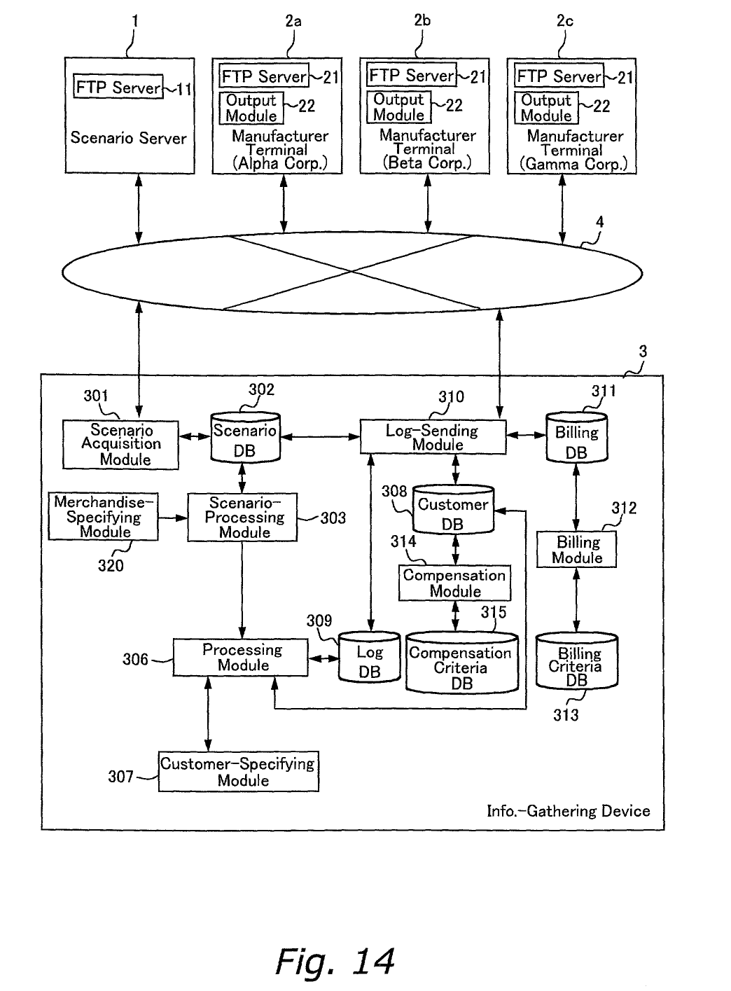

FIG. 14 is an overall configurational view of an information-gathering system having to do with the present embodiment. This system has a configuration similar to the first embodiment, with the exception that a merchandise-specifying module 320 is annexed to the information-gathering device 3. In the figure, configurational elements marked by symbols that are identical with the first embodiment have functions likewise as in the first embodiment. The merchandise-specifying module 320 acquires a merchandise ID by accepting input thereof from a barcode reader, keyboard, etc.

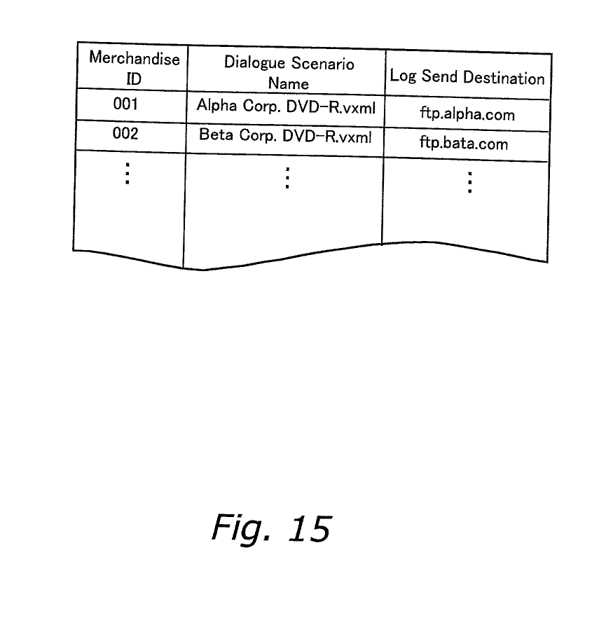

The scenario DB 302, as shown in FIG. 15, assigns correspondences between and stores Merchandise ID, Dialogue Scenario, and Log Send Destination. To each of the merchandise IDs is assigned a correspondence to one dialogue scenario, and to one log send destination indicating a manufacturer terminal of the merchandise.

In the dialogue routine in present embodiment, for step S12 of the dialogue routine noted above, the scenario-processing module 303 accepts input of merchandise ID instead of merchandise name. The log file for the dialogue scenario performed is sent to the log send destination corresponding to the input merchandise ID, i.e., to the manufacturer terminal of the merchandise.

Third Embodiment

In an information-gathering system having to do with a third embodiment, log files matching sending preferences designated through the manufacturer terminals are extracted from the log DB and transmitted to the manufacturer terminals. This system is especially suited to the example situation of a manufacture desiring to do a survey on a rival company's product.

Configuration

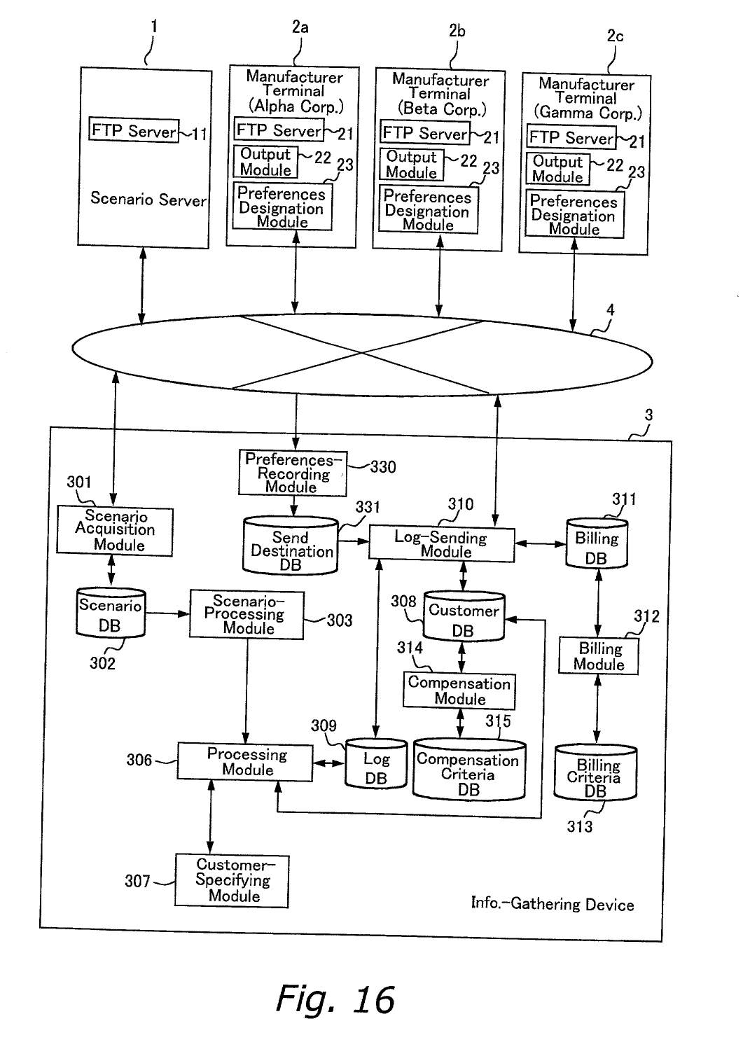

FIG. 16 is an overall configurational view of an information-gathering system having to do with the present embodiment.

This system has a configuration similar to the first embodiment, with the exception that a send destination DB 331 and a preferences-recording module 330 are annexed to the information-gathering device 3, and a preferences designation module 23 is annexed to the manufacturer terminals 2. In the figure, configurational elements marked by symbols that are identical with the first embodiment have functions likewise as in the first embodiment.

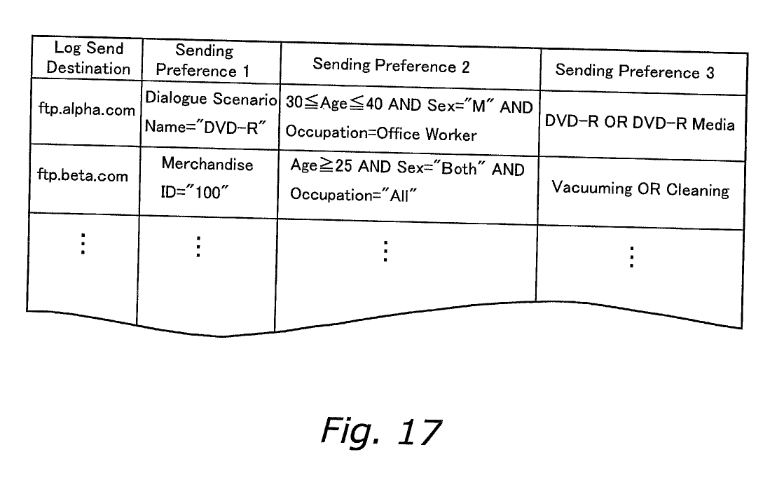

FIG. 17 is a conceptual explanatory diagram of information stored in the log send DB 331. This DB stores manufacturer-designated sending preferences for each manufacturer. In this example, the log send DB 331 includes Log Send Destination, Sending Preference 1, Sending Preference 2 and Sending Preference 3. The log-file sending preferences may be, to give examples, merchandise ID, merchandise name, customer personal information, or keywords contained in the dialogues. Herein, a manufacturer who is specified as the log send destination of <ftp.alpha.com> has designated merchandise ID for Sending Preference 1, customer personal information for Sending Preference 2, and keywords included in dialogue content for Sending Preference 3.

The preferences designation module 23 accepts and transmits to the information-gathering device 3 designation of log-file sending preferences.

The preferences-recording module 330 writes the sending preferences transmitted from the preferences designation module 23 into the send destination DB 331.

It will be understood that the log-sending module 310 has the same functions as the first embodiment. Nevertheless, it differs from the first embodiment in that at predetermined periodic intervals, it does an extraction for each manufacturer of log files that match the sending preferences, and transmits the extracted log files to the manufacturer terminals 2.

Further, there is no need to store log send destinations in the scenario DB 302.

Process Flow

Process flow in the present embodiment is likewise as in the first embodiment, excepting that a later described Preference Designation Routine is carried out, and that the transmission routine will be a later described Transmission Routine (Third Embodiment).

(1) Preferences Designation Routine

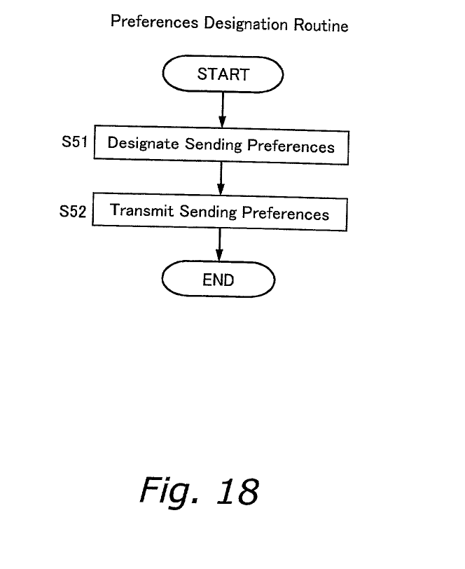

FIG. 18 is a flow chart illustrating flow in a preferences designation routine that the preferences designation module 23 in the manufacturer terminal 2 carries out. By, for example, the pressing of a Set Sending Preferences Button that the preferences designation module 23 displays, the following routine is initiated.

Step S51: The preferences designation module 23 displays a preferences designation screen for accepting designation of log-file sending preferences, and accepts designation of sending preferences.

Step S52: When a Send Button or Set Button or the like on the just-noted preferences designation screen is pressed, the preferences designation module 23 transmits the designated sending preferences to the information-gathering device 3. Also, network address for the manufacturer terminal 2 is put together with the sending preferences and transmitted. The preferences-recording module 330 in the information-gathering device 3 writes the manufacturer terminal addresses, i.e., the log send destinations, and the received sending preferences into the send destination DB 331.

(2) Transmission Routine

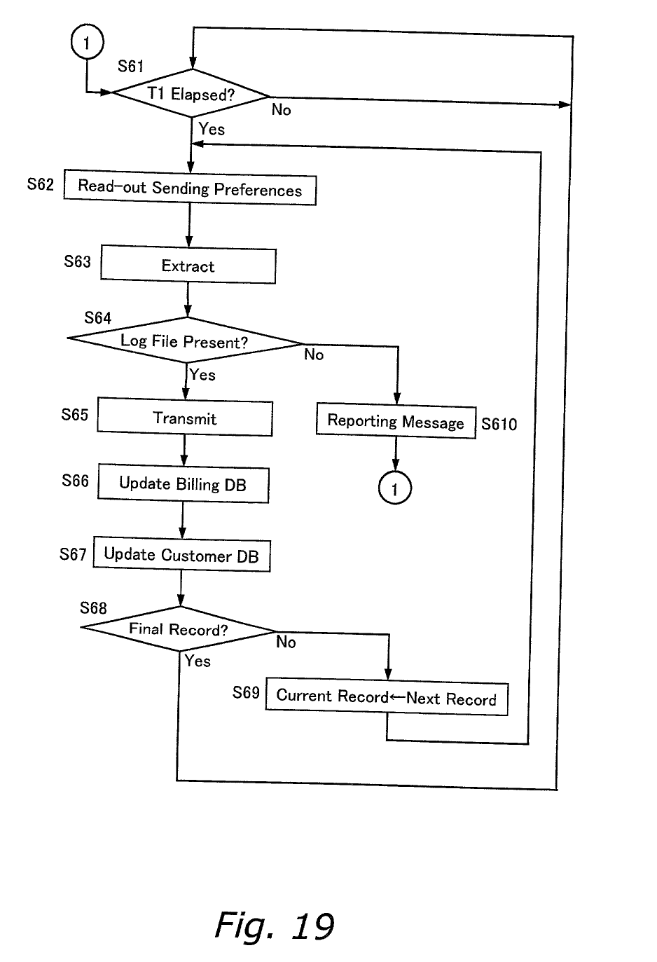

FIG. 19 is a flow chart illustrating flow of the transmission routine in the present embodiment. In this routine, the log-sending module 310, monthly for example, extracts from the log DB 309 and sends to the manufacturer terminals 2 log files that fit the sending preferences stored in the send destination DB 331.

Step S61: The log-sending module 310 judges whether or not a set time period T1 has elapsed since the last time log files were sent. If elapsed, the following steps ensue for transmission of the log files. If not elapsed, step S61 is repeated.

Step S62: The log-sending module 310 consults the current record in the send destination DB 331 and reads out the log send destination and the sending preferences (“current sending preferences” hereinafter). The initial record is the default for the current record.

Step S63: The log-sending module 310 consults the log DB 309 and extracts the log file that matches the current sending preference.

Steps S64, S65: If there is a log file that matches the current sending preference (S64), the log-sending module 310 transmits it to the log send destination in the current record (S65). If there is no log file that matches, later described step S610 ensues.

Step S66: The log-sending module 310 computes the gross size of all the extracted log files combined, and thereby updates the billing DB 311. That is, the log-sending module 310 updates the Accumulated File Size for the just-noted log send destination by summing the gross size with log send destination Accumulated File Size.

Step S67: The log-sending module 310 updates the customer DB 308 based on the extracted log file size. That is, the log-sending module 310 determines an updating target record in the customer DB 308 with the customer ID that corresponds to the extracted log file as a key. Subsequently, the log-sending module 310 sums the extracted log file size onto the Accumulated File Size. If there is a plurality of extracted log files, respective Accumulated File Sizes for a plurality of customers is updated.

Step S68: The log-sending module 310 judges whether or not the current record is the final record in the send destination DB 331. If it is the final record, the routine returns to step S61 and stands by for time T1 to elapse. If it is not the final record, step S69 ensues.

Step S69: The log-sending module 310 sets as the current record the record succeeding the current record, and the routine returns to step S62 and transmits the log file that matches a fresh sending preference.

Step S610: If there are no log files that match the sending preference, the log-sending module 310 transmits a message to the manufacturer terminal 2 reporting to that effect. For example, a message such as, “There are no results this month for the selected questionnaire” is transmitted.

Thus, as in the foregoing, transmission of log files fitting preferences that manufacturers designate is made, e.g., every month.

Screen Example

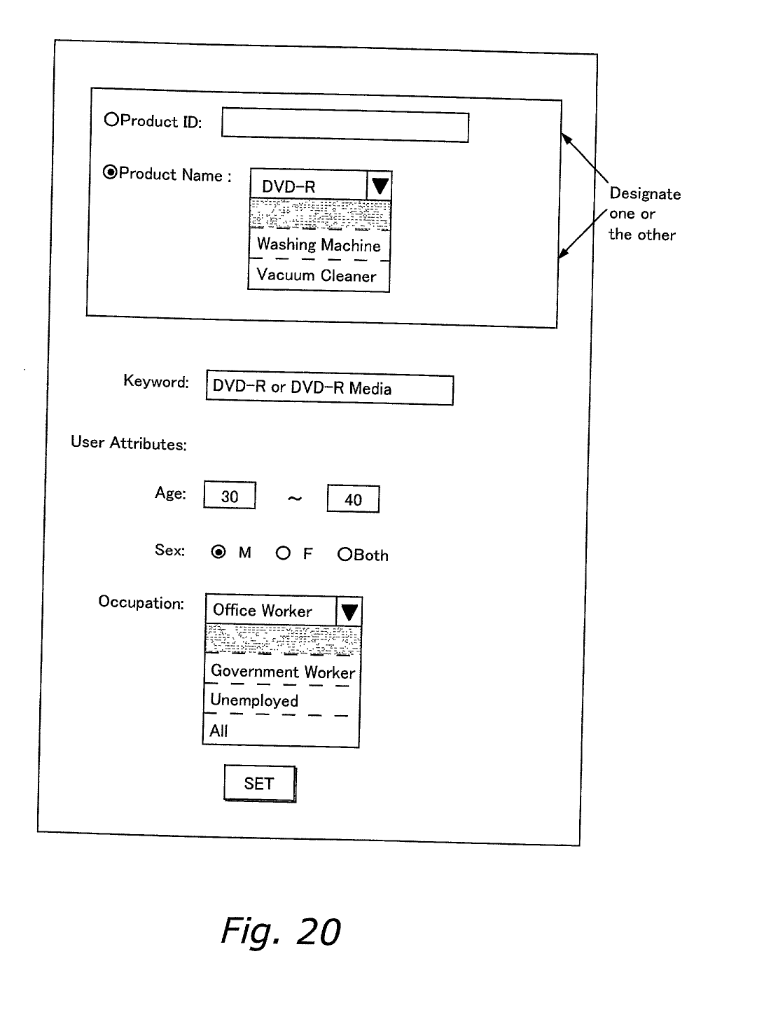

FIG. 20 is one example of a preferences designation screen displayed on a manufacturer terminal 2. This screen enables designation of either Merchandise ID or Merchandise Name. As a merchandise name, any displayed by a pull-down menu can be selected. Also, as keywords, words of choice contained in dialogue content can be designated. Further, as user attributes, customer age-level, sex, and occupation can be designated. When these preferences are set and a SET Button is pressed, the set sending preferences are transmitted from the manufacturer terminal 2 to the information-gathering device 3.

Other Embodiments

(A) Dialogue Content Processing

In the foregoing dialogue routine, processing of dialogue content is not limited to conversion into text data from voice data and annexing of personal information. The dialogue routine may include a process that edits the output questions and input answers into a visually manifest form, to give one example. Further, not only customer personal information but also purchasing histories may be utilized as annex information that is added onto the dialogue content.

(B) Other Modes for the Transmission Routine

In the foregoing transmission routine, transmission of log files is made at every fixed time interval, but carrying out transmission each time log files are generated is also possible.

Further, the log DB 309 can have transmission flags that check off whether or not log files have been sent. Flagging transmitted log files with a transmission flag enables distinguishing whether a log file is sent or unsent. In this way, records in the log DB 309 do not have to be periodically deleted, and unsent records may be targeted for transmission.

(C) Other Modes for the Billing Routine and Compensation Routine

Billing totals and compensation in the foregoing billing routine and compensation routine are determined according to transmitted file size. Nevertheless, billing totals and compensation may be determined according to number of transmitted files, and count of dialogues held. Further, log file effectiveness level conceivably could be decided in accordance with the proportion at which keywords are contained in log files, and the billing totals and compensation determined according to the effectiveness level.

(D) Designation of the sending preferences is carried out on the manufacturer terminals 2 in the foregoing third embodiment. On the other hand, carrying this out on the information-gathering device 3 is also possible.

(E) The present invention comprehends a program for executing the processing methods in the foregoing information-gathering system, as well as computer readable recording media on which the program is recorded. Computer-read/writeable floppy disks, hard disks, semiconductor memory, CD-ROMs, DVDs, magneto-optical disks (MOs) and other recording media give some examples.

(F) The dialogue scenario may be composed to contain merchandise explanatory information, and the information-gathering device may serve at the same time as a merchandise-introducing device. This situation enables the information-gathering device while introducing merchandise to conduct a survey on the merchandise more naturally. Furthermore, practical application as a device that is made a substitute for shop clerks at franchises or that works to support shop clerks is also possible. Herein, a data base for administrating conditions under which the dialogue scenarios are used would be provided, so that each time a dialogue scenario is acquired, the acquiring information-gathering device and frequency would be administrated, so as to charge a use fee for the dialogue scenario. This may be such that the billing routine is offset.

By employing the present invention, survey results on merchandise are automatically transmitted to businesses via a network, which lets businesses effectively gather feelings from customers.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. An information-gathering method employed in an information-gathering system for holding dialogues with customers based on dialogue scenarios, the information-gathering method comprising:
a scenario-storing step of assigning correspondences between, and storing, dialogue scenarios, and send-destination addresses for content of dialogues performed following the dialogue scenarios;
an extraction step of extracting from the stored dialogue scenarios a dialogue scenario to be performed;
a dialogue step of holding a dialogue with a customer following the dialogue scenario and acquiring content of the dialogue;
a dialogue transmission step of transmitting the dialogue content to the send-destination address corresponding to the dialogue scenario;
a dialogue storing step of storing the transmitted dialogue content; and
an output step of outputting the dialogue content stored in said dialogue storing step.

2. An information-gathering device for holding dialogues with customers based on dialogue scenarios, the information-gathering device including:
scenario storage means for assigning correspondences between and storing dialogue scenarios, and send-destination addresses for content of dialogues performed following the dialogue scenarios;
extraction means for extracting from the stored dialogue scenarios a dialogue scenario to be performed;
dialogue means for holding a dialogue with a customer following the dialogue scenario and for acquiring content of the dialogue; and
information transmission means for transmitting the dialogue content to the send-destination address corresponding to the dialogue scenario.

3. The information-gathering device set forth in claim 2, further including:
customer information storage means for assigning correspondences between and storing customer-identifying data for identifying a customer, and customer information;
customer-specifying means for accepting input of the customer-identifying data; and
processing means for extracting from said customer information storage means, and annexing to the dialogue content, customer information corresponding to the input customer-identifying data.

4. The information-gathering device set forth in claim 2, further including dialogue storage means for storing the dialogue content.

5. The information-gathering device set forth in claim 2, further including merchandise-specifying means for accepting input of merchandise identification data for identifying merchandise, wherein:
said scenario storage means correspondingly assigns to the dialogue scenarios, and further stores, merchandise identification data, and moreover stores as the send-destination addresses communications addresses for providers of the merchandise identified by the merchandise identification data;
said extraction means extracts dialogue scenarios corresponding to input merchandise identification data; and
said information transmission means transmits the dialogue content to the communications addresses corresponding to the merchandise identification data.

6. The information-gathering device set forth in claim 2, further including a merchandise name-specifying means for accepting merchandise classification input, wherein:
said scenario storage means further stores merchandise classifications, and moreover stores as the send-destination addresses communications addresses for providers of merchandise identified by the merchandise classifications;
said extraction means extracts a dialogue scenario corresponding to an input merchandise classification; and
said information transmission means transmits the dialogue content to the communications addresses corresponding to the input merchandise classifications.

7. The information-gathering device set forth in claim 2, further including:
criteria storage means for storing billing criteria for billing for transmitted dialogue content;
billing means for determining based on the billing criteria billing totals regarding the dialogue content; and
notification means for reporting the billing totals to the send-destination addresses for the dialogue content.

8. The information-gathering device set forth in claim 2, further including:
compensation criteria storage means for assigning correspondences between, and storing, evaluation criteria for determining compensation provided to the customer according to the acquired dialogue content, and the compensation;
compensation determining means for determining compensation for the dialogue based on the evaluation criteria; and
compensation notification means for reporting compensation to the customer with whom the dialogue has been held.

9. A computer-readable storage medium on which is recorded an information-gathering program utilized in an information-gathering device for holding dialogues with customers based on dialogue scenarios, the computer-readable storage medium on which is recorded an information-gathering program executing:
a scenario-storing step of assigning correspondences between, and storing, dialogue scenarios, and send-destination addresses for content of dialogues performed following the dialogue scenarios;
an extraction step of extracting from the stored dialogue scenarios a dialogue scenario to be performed;
a dialogue step of holding a dialogue with a customer following the dialogue scenario and acquiring content of the dialogue; and
an information transmission step of transmitting the dialogue content to the send-destination address corresponding to the dialogue scenario.

10. An information-gathering program for enabling a computer to hold dialogues with customers based on dialogue scenarios, the information-gathering program for enabling a computer to function as:
scenario storage means for assigning correspondences between and storing dialogue scenarios, and send-destination addresses for content of dialogues performed following the dialogue scenarios;
extraction means for extracting from the stored dialogue scenarios a dialogue scenario to be performed;
dialogue means for holding a dialogue with a customer following the dialogue scenario and for acquiring content of the dialogue; and
information transmission means for transmitting the dialogue content to the send-destination address corresponding to the dialogue scenario.

11. A computer terminal including:
information-gathering means connected via a network to the information-gathering device set forth in claim 2, for gathering dialogue content transmitted from said information-gathering device;
information storage means for storing the gathered dialogue content; and
output means for outputting the stored dialogue content.

12. An information-gathering method employed in an information-gathering system for holding dialogues with customers based on dialogue scenarios, the information-gathering method comprising:
a scenario-storing step of storing dialogue scenarios;
an extraction step of extracting from the dialogue scenarios a dialogue scenario to be performed;
a dialogue step of holding a dialogue with a customer following the dialogue scenario and acquiring content of the dialogue;
a first dialogue-storing step of storing the acquired dialogue content;
a sending-preferences designation step of accepting designation of sending preferences, and send-destination addresses, for the stored dialogue content;
a sending-preferences storage step of assigning correspondences between and storing the send-destination addresses and the sending preferences;
a transmission step of extracting from the stored dialogue content and transmitting to the send-destination addresses dialogue substance matching the sending preferences;
a second dialogue-storing step of storing the transmitted dialogue substance; and
an output step of outputting the dialogue substance stored in said second dialogue-storing step.

13. An information-gathering device for holding dialogues with customers based on dialogue scenarios concerning merchandise, connected via a network with computer terminals for providers of the merchandise, the information-gathering device comprising:
scenario storage means for storing dialogue scenarios;
extraction means for extracting from the dialogue scenarios a dialogue scenario to be performed;
dialogue means for holding a dialogue with a customer following the dialogue scenario and for acquiring content of the dialogue;
dialogue storage means for storing the acquired dialogue content;
sending-preferences acceptance means for accepting from the computer terminals designation of sending preferences, and send-destination addresses, for the stored dialogue content;
sending-preferences storage means for assigning correspondences between and storing the send-destination addresses and the sending preferences; and
dialogue transmission means for extracting from the stored dialogue content and transmitting to the send-destination addresses dialogue substance matching the sending preferences.

14. A computer terminal connected via a network with dialogue devices for holding dialogues with customers based on dialogue scenarios concerning merchandise, the computer terminal including:
sending-preferences designation means for accepting designation of sending preferences, and send-destination addresses, for dialogue content acquired through the dialogue scenarios;
sending-preferences notification means for transmitting to the dialogue devices the designated sending preferences and send-destination addresses;
gathering means for gathering from the dialogue devices dialogue content matching the sending preferences;
dialogue storage means for storing dialogue content gathered by said gathering means; and
output means for outputting the dialogue content stored by said dialogue storage means.
